(19) United States
(12) Patent Application Publication
(10) Pub. No.: US 2009/0131138 A1
(43) Pub. Date: May 21, 2009

(54) SYSTEM AND METHOD FOR ADVANCED LOTTERY WAGERING

(76) Inventor: Bezalel LENZIZKY, Jerusalem (IL)

Correspondence Address: Pearl Cohen Zedek Latzer, LLP, 1500 Broadway, 12th Floor, New York, NY, 10036, US

(21) Appl. No.: 11/941,943

(22) Filed: Nov. 18, 2007

(51) Int. Cl. G06F 13/00; G06F 15/167

(52) U.S. Cl. 463/17; 709/213

(57) ABSTRACT

A system and method of display of data about lottery contests including data about which of such contests may be open, an amount to be won in such contest, a probability of winning such contest and a time remaining before an end of such contest.

### BACKGROUND OF THE INVENTION

For many, buying or investing in a lottery ticket is a blind bet, made without significant thought or calculation. To some, lottery wagering involves mathematical calculations and figuring of probabilities, timing and skill in predicting the trends of an unseen crowd, and determining the most promising contests to enter and the best strategies for success. The efforts of these calculating participants are frequently frustrated by the obscure and opaque practices of lottery organizations who display only eye-popping numbers of fantastic winnings rather than the myriad statistics that would help the serious player in his efforts.

### SUMMARY OF THE INVENTION

Some embodiments of the invention may include a user interface of a computer system for analyzing lottery contest data showing concurrently an indication of two or more lottery contests, an indication of a probability of winning such two or more lottery contests, an indication of an amount to be won in such two or more lottery contests, and an indication of a time remaining until an end of such two or more lottery contests.

In some embodiments, the interface may include an indication of a sum bet by a user on at least one of such two or more lottery contests.

In some embodiments, the interface may include an indication of a present value to a user of winning at one or more of such two or more lottery contests.

In some embodiments, the interface may include an indication of a wager placed by a user on at least one of such two or more lottery contests.

In some embodiments, the interface may include an indication of two or more users who have bet on a lottery contest of such two or more lottery contests.

In some embodiments, such two or more lottery contests may include contests that are open for participation concurrently, where such two or more contests have different end times.

In some embodiments, such two or more lottery contests may include contests that are open for participation concurrently, where such two or more contests have different minimum wager amounts.

In some embodiments the interface may include an indication of numbers upon which bets have been placed in one of such two or more contests.

Some embodiments may include a computer readable-medium, having stored instructions, that when executed on a computing platform, result in accepting data about two or more lottery contests, presenting a probability of winning at least one of such two or more lottery contests, presenting a time remaining until a close of at least one of such two or more lottery contests, and presenting an amount to be won in at least one of such two or more lottery contests.

In some embodiments, there may be include instructions that when executed result in accepting a wager from a participant in at least one of such lottery contests.

In some embodiments, there may be included instructions that when executed result in storing a total wagered amount of a user on at least one of such two or more lottery contests.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system in accordance with an embodiment of the invention; and

FIG. 2 is a schematic presentation of a user interface presenting data on lottery contests in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. Some embodiments may be expressed as an interface or presentation that may be displayed to a user by way of for example a computer display, and by which a user may observe and appreciate a significance of data. In some embodiments data on many contests may be presented concurrently. An indication of a lottery or other event may, in addition to its regular definition include a graphic, numeric, textual or other depiction or description of a lottery or similar contest or data concerning such contest. When used herein, the term lottery or lottery contest may in addition to its regular meaning, refer to a drawing or entry selection contest or game wherein a participant may submit one or more numbers or other units, and wherein a selection of such submitted numbers or unit may make the participant eligible for a prize.

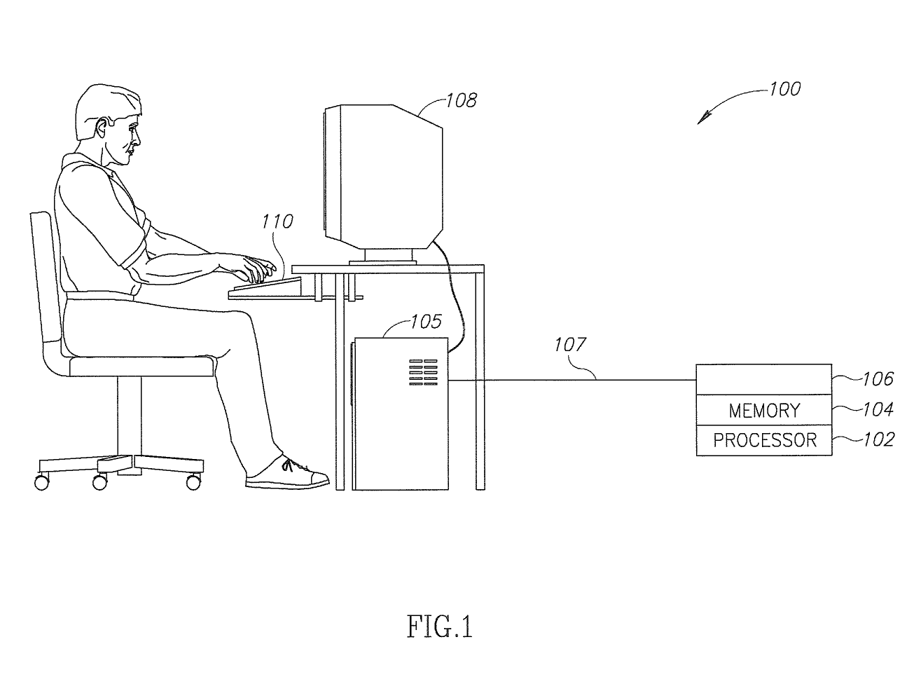

Reference is made to FIG. 1, a schematic diagram of a system in accordance with an embodiment of the invention. In some embodiments, system 100 may include processor 102 and a memory 104 that may be housed for example in one or more components such as a computer platform 105. In some embodiments, a separate computer 106 may be located remotely and may be connected to system 100 in a networked configuration over one or more wired or wireless connections 107. System 100 may include a display 108 that may be connected to for example remote computer 106. Computer platform 105 may also include an input device 110 such as for example a mouse or keyboard. In some embodiments, a user of computer platform 105 may enter data relating to one or more lottery contests into input device 110 and may view data about such or other contests on display 108.

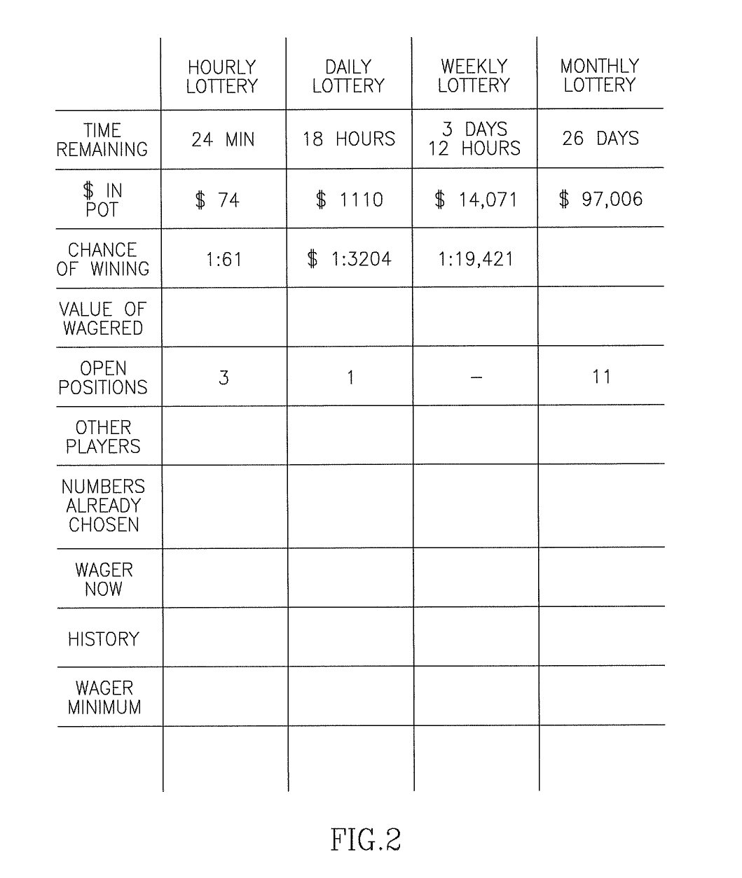

Reference is made to FIG. 2 a schematic presentation of certain displayed data relating to one or more lottery contests in accordance with an embodiment of the invention. In some embodiments, one, some or several lottery contests may be operated by processor 102 and/or tracked through data collected in memory 104.

In operation, system 100 may run or track several lottery contests at once, where some or all of such contests have different expiration times and dates. The system may track and display some or all of the following data relating to one or more of the contests: the time remaining until the drawing in one or more of the contests, the number of tickets sold for such contests, the size of the pot that is to be paid to the winner of the contest, the probability that the user has of winning in light of the number of tickets or amount of money that he has wagered on a contest and a probability of winning if a particular number is selected for such contest in light of other participants who may have wagered on such numbers.

In operation, processor 102 may operate one or more lottery contests having different execution periods and times. For example, on one or more screens, there may be displayed information about some or all of an hourly, daily, weekly, monthly, six month or annual lottery. Other periodicities are possible. Similarly, there may be displayed data on various contests with the same periodicity or ending on the same time. The display 108 may indicate for one or more of the lotteries, the status of the game—such as completed, closed or open, the time remaining until the drawing, the number of players who wagered on the game, the size of the pot, the probability of any one ticket winning the contest, a calculation of the current value of each dollar wagered on the contest and an indication of which numbers have been wagered upon in one or more contests by the user or by anyone participating in the contest, and who may have bet on such numbers or on any numbers in the contest. One or more of such values and statistics may be displayed concurrently or in related displays or web pages, and a user may view them at the same time or easily transfer between one display and another to collect data on the relative benefits of numerous contests at once. In response, the system 100 may enable the user to place bets to capitalize or exploit opportunities that may become available as is indicated on the shown data.

In some embodiments, a current value calculation of a wager on a contest may be derived by for example the probability that a particular wager will win, the time remaining in the contest, the number of participants who have wagered in the contest and size of the pot. Other calculations are possible, and in some embodiments a user may create or input customized algorithms to calculate a value of a wager in a particular contest.

In some embodiments, a participant may enter and execute wagers directly from the computer, system 100 or display 108 by way of for example input device 110 so that participants may quickly or in real time respond to opportunities that they detect in their monitoring of the data presented by the system 100, by buying or wagering one or multiple lottery tickets or wagers. Purchases or wagers may be made by deducting from a pre-paid account or by for example credit card or other charging system.

In some embodiments, additional data may be displayed such as for example a name or other designation of other bidders in a particular lottery, and how much one or each of such other bidders has bid and the time of such bid. Past practices or history of particular participants or contests, or past participation rates in contests may also be recorded, shown or accessed from a display and may be used as an indication of how a particular game may proceed or how one or more wagers may respond to opportunities in various contests.

In some embodiments, several games that may end at the same time may be open at once, and data may be displayed about such games. For example, a contest that may call for a minimum wager of $5, or some other figure may end or be open at the same time as a contest that calls for a wager of $10, and a display may show relevant data about both or all of such games.

In some embodiments a user may customize the display provided to him to include data about for example only those contests having a pot of above or below a certain sum, or only those contests that are to end in a pre-determined time period. A display may also provide data on a user's then outstanding bets or positions in one or more open contests, and on the sums or aggregate values or success probabilities of one or more of such positions.

In some embodiments, a probability may be displayed as a percentage, as a ratio, as a measure of 1 in 1,000 or other such expression of likelihood.

In some embodiments an interface or display of data or a statistic about a lottery may be provided on the same screen as other data about the game, or in a drop down, roll-over, hyper-link or other viewing alternative as may be desirable to present the relevant data in a clear and legible fashion. In some embodiments, a viewer may determine one or more views of data that may be presented at a particular time or about a particular contest.

Some embodiments of the invention may include a method where in a single view on for example a computer screen, a user may be presented with data about two or more lottery contests, a probability for winning each of such two or more lottery contests, an indication of an amount to be won in each of such two or more lottery contests, and an indication of a time remaining until an end of each of such two or more lottery contests

It will be appreciated by persons skilled in the art that embodiments of the invention are not limited by what has been particularly shown and described hereinabove. Rather the scope of at least one embodiment of the invention is defined by the claims below.

I claim:

1. A user interface of a computer system for analyzing lottery contest data comprising:
an indication of a plurality of lottery contests;
an indication of a probability for winning a contest of said plurality of lottery contests;
an indication of an amount to be won in a contest of said plurality of lottery contests; and
an indication of a time remaining until an end of a contest of said plurality of lottery contests.

2. The user interface as in claim 1, comprising an indication of a sum bet by a user on at least one of said plurality of lottery contests.

3. The user interface as in claim 1, comprising an indication of a present value to a user of winning at a contest of said plurality contests.

4. The user interface as in claim 1, comprising an indication of a wager placed by a user on a contest of said plurality of lottery contests.

5. The user interface as in claim 1, comprising an indication of a plurality of users who have bet on a contest of said plurality of lottery contests.

6. The user interface as in claim 1, wherein said plurality of lottery contests include contests open concurrently, wherein at least two of said plurality of lottery contests having different end times.

7. The user interface as in claim 1, comprising an indication of a plurality of contests open concurrently, wherein at least two of said plurality of contests have different minimum wager amounts.

8. The user interface as in claim 1, comprising an indication of numbers upon which bets have been placed in one of said plurality of contests.

9. A computer readable-medium, having stored thereon instructions, that when executed on a computing platform, result in
accepting data about a plurality of lottery contests;
presenting a probability of winning at least one of said plurality of lottery contests;
presenting a time remaining until a close of at least one of said plurality of lottery contests;
presenting an amount to be won in at least one of said plurality of lottery contests.

10. The computer readable-medium as in claim 9, further comprising instructions that when executed result in accepting a wager from a participant in at least one of said plurality of lottery contests.

11. The computer readable-medium as in claim 9, further comprising instructions that when executed result in storing a total wagered amount of a user on at least one of said plurality of lottery contests.

12. A method of presenting lottery data comprising:
presenting in a single view an indication of a plurality of lottery contests;
presenting in said view an indication of a probability for winning a contest of said plurality of lottery contests;
presenting in said view an indication of an amount to be won in a contest of said plurality of lottery contests; and
presenting in said view an indication of a time remaining until an end of a contest of said plurality of lottery contests.

13. The method as in claim 12, comprising presenting in said view an indication of a sum bet by a user on at least one of said plurality of lottery contests.
